(19) United States
(12) Patent Application Publication
(10) Pub. No.: US 2007/0195244 A1
(43) Pub. Date: Aug. 23, 2007

(54) Optical Film And Image Display

(75) Inventors: Minoru Miyatake, Osaka (JP); Shuuji Yano, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Nitto Denko Corporation, Ibaraki-shi (JP)

(21) Appl. No.: 10/594,309

(22) PCT Filed: Mar. 18, 2005
(86) PCT No.: PCT/JP05/04937

§ 371 Date: Sep. 27, 2006

(30) Foreign Application Priority Data
Mar. 29, 2004 (JP) 2004-095892

(51) Int. Cl. G02F 1/1335

(52) U.S. Cl. 349/118

(57) ABSTRACT

An optical film for a liquid crystal display of the invention laminated a polarizing plate and a retardation film so that an absorption axis of the polarizing plate and a slow axis of the retardation film are perpendicular or parallel to each other, wherein the polarizing plate comprises a transparent protective film on both surfaces of a complex type scattering-dichroic absorbing polarizer including a film that has a structure having a minute domain dispersed in a matrix formed of an optically-transparent water-soluble resin including an absorbing dichroic material, and the transparent protective film satisfies that an in-plane retardation Re₁=(nx₁−ny₁)×d₁ is 10 nm or less and a thickness direction retardation Rth={(nx₁+ny₁)/2−nz₁}×d₁ is in the range of from 30 nm to 100 nm; and the retardation film satisfies that an Nz value represented by Nz=(nx₂−nz₂)/(nx₂−ny₂) is in the range of from 0.1 to 0.8 and an in-plane retardation Re₂=(nx₂−ny₂)×d₂ is in the range of from 60 to 300 nm. The optical film for a liquid crystal display has a high contrast ratio over a wide range, a high transmittance, and a high degree of polarization and in which uneven transmittance can be suppressed when black viewing is displayed, and capable of realizing a better view in a case where the optical film is applied to a liquid crystal display driving in IPS mode.

### TECHNICAL FIELD

This invention relates to an optical film laminated a polarizing plate and a retardation film. The optical film of the invention is suited for use in a liquid crystal display driving in IPS mode, and particularly, for use in a transmissive liquid crystal display.

### BACKGROUND ART

Liquid crystal display are rapidly developing in market, such as in clocks and watches, cellular phones, PDAs, notebook-sized personal computers, and monitor for personal computers, DVD players, TVs, etc. In the liquid crystal display, visualization is realized based on a variation of polarization state by switching of a liquid crystal, where polarizers are used based on a display principle thereof. Particularly, usage for TV etc. increasingly requires display with high luminance and high contrast, polarizers having higher brightness (high transmittance) and higher contrast (high polarization degree) are being developed and introduced.

Conventionally, as a liquid crystal display, there has been used a liquid crystal display in TN mode in which a liquid crystal having a positive dielectric anisotropy is twisted aligned between substrates mutually facing to each other. However, in TN mode, when black viewing is displayed, optical leakage resulting from birefringence caused by liquid crystal molecule near a substrate made it difficult to obtain perfect display of black viewing owing to driving characteristics thereof. On the other hand, in a liquid crystal display in IPS mode, since liquid crystal molecule has almost parallel and homogeneous alignment to a substrate surface in non-driven state, light passes through the liquid crystal layer, without giving almost any change to a polarization plane, and as a result, arrangement of polarizing plates on upper and lower sides of the substrate enables almost perfect black viewing in non-driven state.

Although almost perfect black viewing may be realized in normal direction to a panel in IPS mode, when a panel is observed in oblique direction, inevitable optical leakage occurs caused by characteristics of a polarizing plate in a direction shifted from an optical axis of the polarizing plates placed on upper and lower sides of the liquid crystal cell, as a result, leading to a problem of narrowing of a viewing angle. That is, in a polarizing plate using a triacetyl cellulose (TAC) film that has been generally used as a protective film, there has remained a problem that a viewing angle is narrowed due to birefringence that the TAC film has.

In order to solve this problem, there has been used a polarizing plate that is compensated a geometric axis shift of a polarizing plate generated when observed in an oblique direction by a retardation film (see, for example, Japanese Patent Application Laid-Open (JP-A) No 4-305602 and JP-A No. 4-371903). The retardation film has been used as a protective film for a polarizer in the polarizing plate described in the published patent applications. With the retardation film described in the published patent applications, however, it is difficult to achieve a sufficiently wide viewing angle in IPS mode liquid crystal display.

Dichroic absorbing polarizers such as iodine based polarizers comprising stretched polyvinyl alcohol on which iodine is adsorbed are widely used, because they have high transmittances and high degrees of polarization (JP-A No. 2001-296427). However, iodine based polarizers have relatively low degrees of polarization on the short wavelength side and thus have a problem with hue, such as blue dropout on the short wavelength side during black viewing and yellowing during white viewing.

Iodine based polarizers can also easily suffer from uneven iodine adsorption. Such unevenness can be detected as uneven transmittance particularly during black viewing and cause the problem of a reduction in visibility. In order to solve the problem, for example, there are proposed a method in which the amount of iodine adsorbed on iodine based polarizer is increased such that the transmittance for black viewing does not exceed the lower limit of sensitivity of human eyes and a method employing a stretching process that is resistant to causing unevenness itself. However, the former method has a problem in which the transmittance for white viewing is also reduced in the same way as the transmittance for black viewing so that display itself becomes dark. The latter method also has a problem in which a certain process has to be entirely replaced so that the productivity can be reduced.

### DISCLOSURE OF INVENTION

It is an object of the invention to provide an optical film laminated a polarizing plate and a retardation film that has a high contrast ratio over a wide range, a high transmittance, and a high degree of polarization and in which uneven transmittance can be suppressed when black viewing is displayed, and capable of realizing a better view in a case where the optical film is applied to a liquid crystal display driving in IPS mode.

It is another object of the invention to provide a liquid crystal display, driving in IPS mode, using the optical film and being capable of realizing a better view having a high contrast ratio over a wide range.

As a result of examination wholeheartedly performed by the present inventors that the above-mentioned subject should be solved, it was found out that the above-mentioned purpose might be attained using an optical films shown below, leading to completion of this invention.

That is, this invention relates to an optical film for a liquid crystal display laminated a polarizing plate and a retardation film so that an absorption axis of the polarizing plate and a slow axis of the retardation film are perpendicular or parallel to each other, wherein the polarizing plate comprises a transparent protective film on both surfaces of a complex type scattering-dichroic absorbing polarizer including a film that has a structure having a minute domain dispersed in a matrix formed of an optically-transparent water-soluble resin including an absorbing dichroic material, and

the transparent protective film satisfies that an in-plane retardation Re₁=(nx₁−ny₁)×d₁ is 10 nm or less and

a thickness direction retardation Rth={(nx₁+ny₁)/2−nz₁}×d₁ is in the range of from 30 nm to 100 nm, where a direction on the transparent protective film in which an in-plane refractive index gives maximum is defined as X axis, a direction perpendicular to X axis is defined as Y axis, a direction of the film thickness is defined as Z axis; and refractive indices at 550 nm in the respective axes directions are defined as nx₁, ny₁ and nz₁; and a thickness of the film is defined as d₁ (nm); and

the retardation film satisfies that an Nz value represented by Nz=(nx₂−nz₂)/(nx₂−ny₂) is in the range of from 0.1 to 0.8 and

an in-plane retardation Re₂=(nx₂−ny₂)×d₂ is in the range of from 60 to 300 nm,

where a direction on the retardation film in which an in-plane refractive index gives maximum is defined as X axis, a direction perpendicular to X axis is defined as Y axis, a direction perpendicular to X axis is defined as Y axis, a direction of the film thickness is defined as Z axis; and refractive indices at 550 nm in the respective axes directions are defined as nx₂, ny₂ and nz₂; and a thickness of the film is defined as d₂ (nm).

The minute domain of the complex type absorbing polarizer is preferably formed by an oriented birefringent material. The above-mentioned birefringent material preferably shows liquid crystallinity at least in orientation processing step.

The above-mentioned polarizer of this invention has an iodine based polarizer formed by an optically-transparent water-soluble resin and an absorbing dichroic material as a matrix, and has dispersed minute domains in the above-mentioned matrix. Minute domains are preferably formed by oriented materials having birefringence, and particularly minute domains are formed preferably with materials showing liquid crystallinity. Thus, in addition to function of absorption dichroism by absorbing dichroic materials, characteristics of having function of scattering anisotropy improve polarization performance according to synergistic effect of the two functions, and as a result a polarizer having both of transmittance and polarization degree, and excellent visibility may be provided.

Scattering performance of anisotropic scattering originates in refractive index difference between matrixes and minute domains. For example, if materials forming minute domains are liquid crystalline materials, since they have higher wavelength dispersion of Δn compared with optically-transparent water-soluble resins as a matrix, a refractive index difference in scattering axis becomes larger in shorter wavelength side, and, as a result, it provides more amounts of scattering in shorter wavelength. Accordingly, an improving effect of large polarization performance is realized in shorter wavelengths, compensating a relative low level of polarization performance of an iodine based polarizer in a side of shorter wavelength, and thus a polarizer having high polarization and neutral hue may be realized.

A polarizing plate used in the optical film of the invention is a complex type absorbing polarizing plate in which a protective film having a prescribed retardation values is laminated on both surfaces of a complex type absorbing polarizer. The optical film can prevent light leakage in a direction deviated from an optical axis with the specific retardation film in a case where the complex type absorbing polarizing plate is arranged in the cross-Nichols positional relation and, for example, can be preferably employed in IPS mode liquid crystal display. The optical film of the invention has especially a function compensating reduction in contrast in a liquid crystal layer in an oblique direction. The optical film is a laminate obtained by laminating a polarizing plate and a retardation film so that the absorption axis of the polarizing plate and the slow axis of the retardation film are perpendicular to each other.

A transparent protective film of the polarizing plate has an in-plane retardation Re₁ of 10 nm or less and preferably 6 nm or less, while has a thickness direction retardation Rth in the range of 30 to 100 nm and preferably in the range from 30 to 60 nm. The invention is to obtain an optical film high in compensation effect using a retardation film in a case of using a transparent protective film for a polarizer having such retardations. No specific limitation is imposed on a thickness of the transparent protective film d₁ and the thickness has a value generally 500 μm or less and preferably in the range of from 1 to 300 μm. The thickness is especially preferably in the range of from 5 to 200 μm.

The Nz value of the retardation film is in the range of from 0.1 to 0.8 and the in-plane retardation Re₂ is in the range of 60 to 300 nm. The Nz value is preferably 0.2 or more and more preferably 0.25 or more from the standpoint of enhancement in compensation function. On the other hand, the Nz value is preferably 0.6 or less and more preferably 0.55 or less from the standpoint of enhancement in compensation function. The in-plane retardation Re₂ is preferably 123 nm or more and more preferably 128 nm or more from the standpoint of enhancement in compensation function. While the optical film of the invention is employed in, for example, an IPS mode liquid crystal display, the in-plane retardation Re₂ of the retardation film is preferably in the range of from 100 to 160 nm in a case where the optical film is used only on one side of the liquid crystal cell in mode liquid crystal display. In this case, the in-plane retardation Re₂ is more preferably 150 nm or less and further more preferably 145 nm or less. Note that in a case where the optical films are disposed on both sides of a liquid crystal cell in IPS mode liquid crystal display, the retardation film used in the optical film disposed on the light incidence side, as described later, is preferably smaller in in-plane retardation Re₂ than the retardation film used in the optical film disposed on the viewing side. No specific limitation is placed on a thickness d₂ of the retardation film, the thickness d₂ of the retardation film is usually in the range of from about 40 to 100 μm and preferably in the range of from 50 to 70 μm.

In the above-mentioned optical film, it is preferable that the minute domains of the complex type absorbing polarizer have a birefringence of 0.02 or more. In materials used for minute domains, in the view point of gaining larger anisotropic scattering function, materials having the above-mentioned birefringence may be preferably used.

In the above-mentioned optical film, in a refractive index difference between the birefringent material forming the minute domains and the optically-transparent water-soluble resin of the complex type absorbing polarizer in each optical axis direction, a refractive index difference (Δn¹) in direction of axis showing a maximum is 0.03 or more, and a refractive index difference (Δn²) between the Δn¹ direction and a direction of axes of two directions perpendicular to the Δn¹ direction is 50% or less of the Δn¹

Control of the above-mentioned refractive index difference (Δn¹) and (Δn²) in each optical axis direction into the above-mentioned range may provide a scattering anisotropic film having function being able to selectively scatter only linearly polarized light in the Δn¹ direction, as is submitted in U.S. Pat. No. 2,123,902 specification. That is, on one hand, having a large refractive index difference in the Δn¹ direction, it may scatter linearly polarized light, and on the other hand, having a small refractive index difference in the Δn² direction, and it may transmit linearly polarized light. Moreover, refractive index differences (Δn²) in the directions of axes of two directions perpendicular to the Δn¹ direction are preferably equal.

In order to obtain high scattering anisotropy, a refractive index difference (Δn¹) in an Δn¹ direction is set 0.03 or more, preferably 0.05 or more, and still preferably 0.10 or more. A refractive index difference (Δn²) in two directions perpendicular to the Δn¹ direction is 50% or less of the above-mentioned Δn¹, and preferably 30% or less.

In absorbing dichroic material in the above-mentioned optical film, an absorption axis of the absorbing dichroic material of the complex type absorbing polarizer is preferably orientated in the Δn¹ direction.

The absorbing dichroic material in a matrix is orientated so that an absorption axis of the material may become parallel to the above-mentioned Δn¹ direction, and thereby linearly polarized light in the Δn¹ direction as a scattering polarizing direction may be selectively absorbed. As a result, on one hand, a linearly polarized light component of incident light in an Δn² direction is not scattered or hardly absorbed by the absorbing dichroic material as in conventional iodine based polarizers without anisotropic scattering performance. On the other hand, a linearly polarized light component in the Δn¹ direction is scattered, and is absorbed by the absorbing dichroic material. Usually, absorption is determined by an absorption coefficient and a thickness. In such a case, scattering of light greatly lengthens an optical path length compared with a case where scattering is not given. As a result, polarized component in the Δn¹ direction is more absorbed as compared with a case in conventional iodine based polarizers. That is, higher polarization degrees may be attained with same transmittances.

Descriptions for ideal models will, hereinafter, be given. Two main transmittances usually used for linear polarizer (a first main transmittance k₁ (a maximum transmission direction=linearly polarized light transmittance in an Δn² direction), a second main transmittance k₂ (a minimum transmission direction=linearly polarized light transmittance in an Δn¹ direction)) are, hereinafter, used to give discussion.

In commercially available iodine based polarizers, when the absorbing dichroic material (the iodine based light absorbing materials) are oriented in one direction, a parallel transmittance and a polarization degree may be represented as follows, respectively:

parallel transmittance=0.5×((k₁)²+(k₂)²) and

polarization degree=(k₁−k₂)/(k₁+k₂).

On the other hand, when it is assumed that, in a polarizer of this invention, a polarized light in a Δn¹ direction is scattered and an average optical path length is increased by a factor of α (>1), and depolarization by scattering may be ignored, main transmittances in this case may be represented as k₁ and k₂′=10^{x} (where, x is αlogk₂), respectively

That is, a parallel transmittance in this case and the polarization degree are represented as follows:

parallel transmittance=0.5×((k₁)²+(k₂′)²) and

polarization degree=(k₁−k₂′)/(k₁+k₂′).

When a polarizer of this invention is prepared by a same condition (an amount of dyeing and production procedure are same) as in commercially available iodine based polarizers (parallel transmittance 0.385, polarization degree 0.965: k₁=0.877, k₂=0.016), on calculation, when α is 2 times, k₂ becomes small reaching 0.0003, and as result, a polarization degree improves up to 0.999, while a parallel transmittance is maintained as 0.385. The above-mentioned result is on calculation, and function may decrease a little by effect of depolarization caused by scattering, surface reflection, backscattering, etc. As the above-mentioned equations show, higher value α may give better results and higher dichroic ratio of the absorbing dichroic material (the iodine based light absorbing materials) may provide higher function. In order to obtain higher value α, a highest possible scattering anisotropy function may be realized and polarized light in an Δn¹ direction may just be selectively and strongly scattered. Besides, less backscattering is preferable, and a ratio of backscattering strength to incident light strength is preferably 30% or less, and more preferably 20% or less.

In the above-mentioned optical film, the films used as the complex type absorbing polarizer manufactured by stretching may suitably be used.

In the above-mentioned optical film, minute domains of the complex type absorbing polarizer preferably have a length in an Δn² direction of 0.05 to 500 μm.

In order to scatter strongly linearly polarized light having a plane of vibration in a Δn¹ direction in wavelengths of visible light band, dispersed minute domains have a length controlled to 0.05 to 500 μm in a Δn² direction, and preferably controlled to 0.5 to 100 μm. When the length in the Δn² direction of the minute domains is too short a compared with wavelengths, scattering may not fully provided. On the other hand, when the length in the Δn² direction of the minute domains is too long, there is a possibility that a problem of decrease in film strength or of liquid crystalline material forming minute domains not fully oriented in the minute domains may arise.

The above-mentioned complex type absorbing polarizer and the retardation film are preferably laminated and fixed with a transparent acrylic pressure-sensitive adhesive. If the complex type absorbing polarizer and retardation film are only layered on each other, it would be difficult to form a solid laminate with no space therebetween. Thus, they are preferably bonded together with an optically-transparent adhesive or pressure-sensitive adhesive. The pressure-sensitive adhesive is preferred in terms of convenience of bonding, and an acrylic pressure-sensitive adhesive is preferred in terms of transparency, adhesive properties, weather resistance, and heat resistance.

In the above-mentioned optical film, with regard to the complex type absorbing polarizer, a transmittance to a linearly polarized light in a transmission direction is 80% or more, a haze value is 30% or less, and a haze value to a linearly polarized light in an absorption direction is 30% or more.

A complex type absorbing polarizer of this invention having the above-mentioned transmittance and haze value has a high transmittance and excellent visibility for linearly polarized light in a transmission direction, and has strong optical diffusibility for linearly polarized light in an absorption direction. Therefore, without sacrificing other optical properties and using a simple method, it may demonstrate a high transmittance and a high polarization degree, and may control unevenness of the transmittance in the case of black viewing.

As a complex type absorbing polarizer of this invention, a polarizer is preferable that has as high as possible transmittance to linearly polarized light in a transmission direction, that is, linearly polarized light in a direction perpendicular to a direction of maximal absorption of the above-mentioned absorbing dichroic material, and that has 80% or more of light transmittance when an optical intensity of incident linearly polarized light is set to 100. The light transmittance is preferably 85% or more, and still preferably 88% or more. Here, a light transmittance is equivalent to a value Y calculated from a spectral transmittance in 380 nm to 780 nm measured using a spectrophotometer with an integrating sphere based on CIE 1931 XYZ standard calorimetric system. In addition, since about 8% to 10% is reflected by an air interface on a front surface and rear surface of a polarizer, an ideal limit is a value in which a part for this surface reflection is deducted from 100%.

It is desirable that a complex type absorbing polarizer does not scatter linearly polarized light in a transmission direction in the view point of obtaining clear visibility of a display image. Accordingly, the polarizers preferably has 30% or less of haze value to the linearly polarized light in the transmission direction, more preferably 5% or less; further preferably 3% or less. On the other hand, in the view point of covering unevenness by a local transmittance variation by scattering, a polarizer desirably scatters strongly linearly polarized light in an absorption direction, that is, linearly polarized light in a direction for a maximal absorption of the above-mentioned absorbing dichroic material. Accordingly, a haze value to the linearly polarized light in the absorption direction is preferably 30% or more, more preferably 40% or more, and still more preferably 50% or more. In addition, the haze value here is measured based on JIS K 7136 (how to obtain a haze of plastics-transparent material).

The above-mentioned optical properties are obtained by compounding a function of scattering anisotropy with a function of an absorption dichroism of the polarizer. As is indicated in U.S. Pat. No. 2,123,902 specification, Japanese Patent Laid-Open No. 9-274108, and Japanese Patent Laid-Open No. 9-297204, same characteristics may probably be attained also in a way that a scattering anisotropic film having a function to selectively scatter only linearly polarized light, and a dichroism absorption type polarizer are superimposed in an axial arrangement so that an axis providing a greatest scattering and an axis providing a greatest absorption may be parallel to each other. These methods, however, require necessity for separate formation of a scattering anisotropic film, have a problem of precision in axial joint in case of superposition, and furthermore, a simple superposition method does not provide increase in effect of the above-mentioned optical path length of the polarized light absorbed as is expected, and as a result, the method cannot easily attain a high transmission and a high polarization degree.

The above-mentioned optical film is preferably employed in IPS mode liquid crystal display using an IPS mode liquid crystal cell having a retardation value in the range of from 230 nm to 360 nm at 550 nm when no voltage is applied.

The optical film of the invention is preferably applied to an IPS mode liquid crystal display. No specific limitation is imposed on a particular material as a material applying a liquid crystal cell in IPS mode and one of materials that have been usually used can be properly selected for use, while the optical film of the invention is preferable in that application to a liquid crystal cell having a retardation value in the range of from 230 nm to 360 nm at 550 nm when no voltage is applied can preferably impart a compensation function due to the retardation film to thereto. A retardation value of a liquid crystal cell at 550 nm when no voltage is applied is preferably in the range of from 230 to 360 nm and more preferably in the range of from 250 to 280 nm.

And the present invention related to a transmissive liquid crystal display comprising: a liquid crystal cell containing a pair of substrates between which a liquid crystal layer is sandwiched, and driven in IPS mode; and a pair of polarizing plates disposed on both sides of the liquid crystal cells so that an absorption axis of the polarizing plates are perpendicular to each other, wherein at least one of the polarizing plates is the above-mentioned optical film, and the optical film is disposed so that a retardation film sides face the liquid crystal cell.

In a case where an optical film described above is disposed only on a cell substrate on the viewing side in the transmissive liquid crystal display, it is preferable to adjust an extraordinary index direction of a liquid crystal material in the liquid crystal cell when no voltage is applied and an absorption axis of the polarizing plate on the light incidence side to be parallel to each other.

In a case where an optical film described above is disposed only on a cell substrate on the light incidence side in the transmissive liquid crystal display, it is preferable to adjust an extraordinary index direction of a liquid crystal material in the liquid crystal cell when no voltage is applied and an absorption axis of the polarizing plate in the optical film to be perpendicular to each other.

In the case where the optical film is disposed on the cell substrate on the viewing side or the light incidence side, it is preferable to use the optical film obtained by laminating a polarizing plate and a retardation film to each other so that an absorption axis of the polarizing plate and a slow axis of the retardation film is perpendicular to each other from the standpoint of reduction in influence of dispersion in the retardation film used for controlling polarization.

In a case where optical films described above are disposed on the cell substrates on the viewing side and the light incidence side in the transmissive liquid crystal display, it is preferable to adjust an extraordinary index direction of a liquid crystal material in the liquid crystal cell when no voltage is applied and an absorption axis of the polarizing plate in the optical film on the light incidence side to be parallel to each other.

In a case where the optical films are disposed on the cell substrates on the viewing side and the light incidence side, it is preferable to use the optical film obtained by laminating the polarizing plate and a retardation film to each other so that an absorption axis of the polarizing plate and a slow axis of the retardation film are parallel to each other from the standpoint of reduction in influence of dispersion in the retardation film used for controlling polarization.

In this case, an in-plane retardation value Re₂ of the retardation film in the optical film disposed on the cell substrate on the light incidence side is preferably smaller than an in-plane retardation value Re₂ of the retardation film in the optical film disposed on the cell substrate on the viewing side.

In an IPS mode liquid crystal display of the invention, an optical film of the invention obtained by laminating a complex type absorbing polarizing plate and a retardation film is disposed on one of the surfaces of an IPS mode liquid crystal cell or the optical films of the inventions obtained by the same process are disposed on both surfaces thereof to thereby enable light leakage on black viewing to be reduced that has been conventionally encountered in IPS mode liquid crystal display and enable unevenness on black viewing and blue hue to be neutralized hue without unevenness. Such an IPS mode liquid crystal display has a high contrast ratio over all azimuth angles, thereby enabling a display easy to be viewed in a wide viewing angle to be achieved.

### BRIEF DESCRIPTION OF DRAWING

FIG. 1 is an example showing sectional diagram of an optical film of the invention.

FIG. 2 is conceptual diagram of a liquid crystal display of the invention.

FIG. 3 is conceptual diagram of a liquid crystal display of the invention.

FIG. 4 is conceptual diagram of a liquid crystal display of the invention.

FIG. 5 is a conceptual diagram showing an example of the polarizer of the invention; and

FIG. 6 is a graph showing the polarized absorption spectra of the polarizers in Example 1 and Comparative Example 1.

### BEST MODE FOR CARRYING OUT THE INVENTION

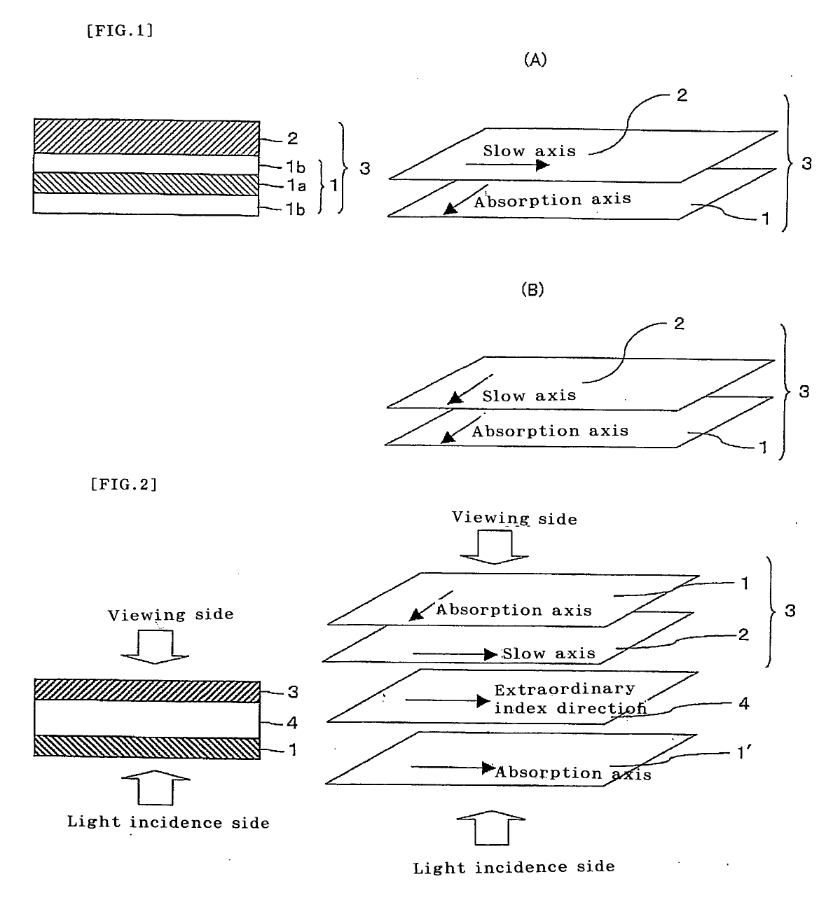

Description is given of an optical film and an image display of the invention with reference to the accompanying drawing. An optical film 3 of the invention is, as shown in FIG. 1, a laminate obtained by laminating a retardation film 2 onto a polarizing plate 1. The polarizing plate 1 that is used is a laminate obtained by laminating a transparent protective film 1b on both surfaces of a complex type absorbing polarizer 1a. It is an example in which a retardation film 2 is laminated onto one surface thereof. The polarizing plate 1 and the retardation film 2 are laminated one on the other so that an absorption axis of the polarizing plate 1 and a slow axis of the retardation film 2 are perpendicular or parallel to each other. FIG. 1(A) shows a case where the absorption axis of the polarizing plate 1 and the slow axis of the retardation film 2 are laminated so as to be perpendicular to each other. FIG. 1(B) shows a case where the absorption axis of the polarizing plate 1 and the slow axis of the retardation film 2 are laminated so as to be parallel to each other.

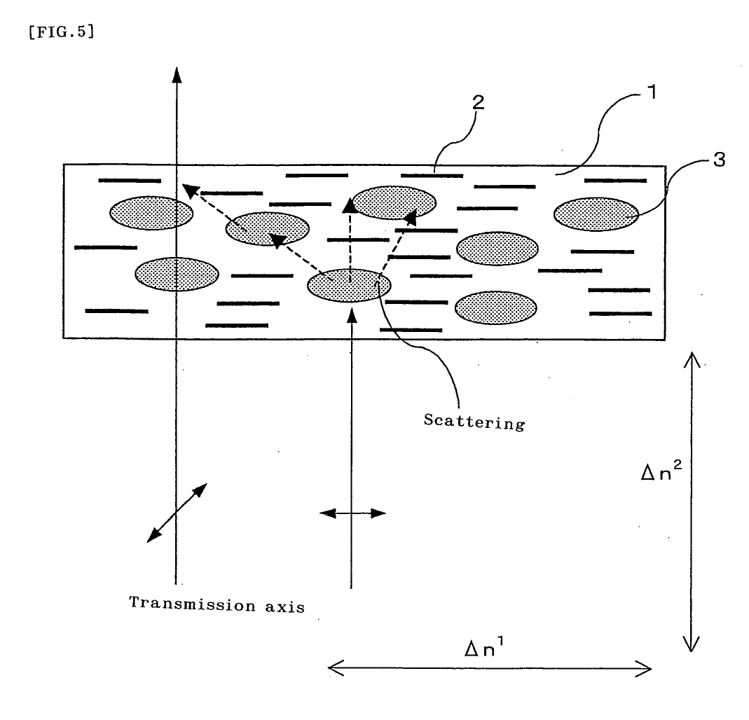

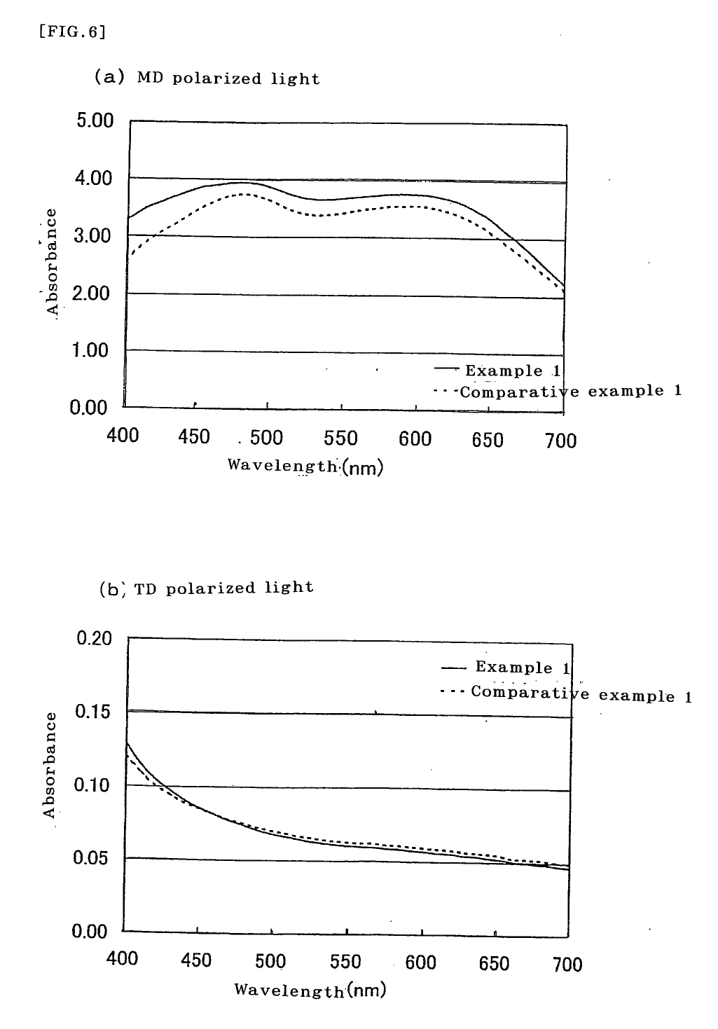

A complex type scattering-dichroic absorbing polarizer of this invention will, hereinafter, be described referring to drawings. FIG. 5 is a conceptual view of a complex type absorbing polarizer of this invention, and the polarizer has a structure where a film is formed with an optically-transparent water-soluble resin 11 including an absorbing dichroic material 12, and minute domains 13 are dispersed in the film concerned as a matrix. As described above, the complex type absorbing polarizer according to the invention includes the absorbing dichroic material 12 preferentially in the optically-transparent thermoplastic resin 11, which forms the film serving as a matrix. However, the absorbing dichroic material 12 may also be allowed to exist in the minute domains 13 as long as it will have no optical effect.

FIG. 5 shows an example of a case where the absorbing dichroic material 12 is oriented in a direction of axis (Δn¹ direction) in which a refractive index difference between the minute domain 13 and the optically-transparent water-soluble resin 11 shows a maximal value. In minute domain 13, a polarized component in the Δn¹ direction is scattered. In FIG. 5, the Δn¹ direction in one direction in a film plane is an absorption axis. In the film plane, an Δn² direction perpendicular to the Δn¹ direction serves as a transmission axis. Another Δn² direction perpendicular to the Δn¹ direction is a thickness direction.

As optically-transparent water-soluble resins 11, resins having optically-transparency in a visible light band and dispersing and absorbing the absorbing dichroic materials may be used without particular limitation. For example, polyvinyl alcohols or derivatives thereof conventionally used for polarizers may be mentioned. As derivatives of polyvinyl alcohol, polyvinyl formals, polyvinyl acetals, etc. may be mentioned, and in addition derivatives modified with olefins, such as ethylene and propylene, and unsaturated carboxylic acids, such as acrylic acid, methacrylic acid, and crotonic acid, alkyl esters of unsaturated carboxylic acids, acrylamides etc. may be mentioned. Besides, as optically-transparent water-soluble resin 11, for example, polyvinyl pyrrolidone based resins, amylose based resins, and etc. may be mentioned. The above-mentioned optically-transparent water-soluble resin may be of resins having isotropy not easily generating orientation birefringence caused by molding deformation etc., and of resins having anisotropy easily generating orientation birefringence.

Examples of the optically-transparent resin 11 also include polyester resins such as polyethylene terephthalate and polyethylene naphthalate; styrene resins such as polystyrene and acrylonitrile-styrene copolymers (AS resins); and olefin resins such as polyethylene, polypropylene, cyclo type- or norbornene structure-containing polyolefins, and olefin based resins such as ethylene-propylene copolymers. Examples thereof also include vinyl chloride resins, cellulose resins, acrylic resins, amide resins, imide resins, sulfone polymers, polyethersulfone resins, polyetheretherketone resin polymers, polyphenylene sulfide resins, vinylidene chloride resins, vinyl butyral resins, arylate resins, polyoxymethylene resins, silicone resins, and urethane resins. One or more of these resins may be used either individually or in any combination. Any cured material of a thermosetting or ultraviolet-curable type resins such as a phenol based, melamine based, acrylic based, urethane, acrylic-urethane based, epoxy based, or silicone based resin may also be used.

In materials forming minute domains 13, it is not limited whether the material has birefringence or isotropy, but materials having birefringence is particularly preferable. Moreover, as materials having birefringence, materials (henceforth, referred to as liquid crystalline material) showing liquid crystallinity at least at the time of orientation treatment may preferably used. That is, the liquid crystalline material may show or may lose liquid crystallinity in the formed minute domain 13, as long as it shows liquid crystallinity at the orientation treatment time.

As materials forming minute domains 13, materials having birefringences (liquid crystalline materials) may be any of materials showing nematic liquid crystallinity, smectic liquid crystallinity, and cholesteric liquid crystallinity, or of materials showing lyotropic liquid crystallinity. Moreover, materials having birefringence may be of liquid crystalline thermoplastic resins, and may be formed by polymerization of liquid crystalline monomers. When the liquid crystalline material is of liquid crystalline thermoplastic resins, in the view point of heat-resistance of structures finally obtained, resins with high glass transition temperatures may be preferable. Furthermore, it is preferable to use materials showing glass state at least at room temperatures. Usually, a liquid crystalline thermoplastic resin is oriented by heating, subsequently cooled to be fixed, and forms minute domains 13 while liquid crystallinity are maintained. Although liquid crystalline monomers after orienting can form minute domains 13 in the state of fixed by polymerization, cross-linking, etc., some of the formed minute domains 13 may lose liquid crystallinity.

As the above-mentioned liquid crystalline thermoplastic resins, polymers having various skeletons of principal chain types, side chain types, or compounded types thereof may be used without particular limitation. As principal chain type liquid crystal polymers, polymers, such as condensed polymers having structures where mesogen groups including aromatic units etc. are combined, for example, polyester based, polyamide based, polycarbonate based, and polyester imide based polymers, may be mentioned. As the above-mentioned aromatic units used as mesogen groups, phenyl based, biphenyl based, and naphthalene based units may be mentioned, and the aromatic units may have substituents, such as cyano groups, alkyl groups, alkoxy groups, and halogen groups.

As side chain type liquid crystal polymers, polymers having principal chain of, such as polyacrylate based, polymethacrylate based, poly-alpha-halo acrylate based, poly-alpha-halo cyano acrylate based, polyacrylamide based, polysiloxane based, and poly malonate based principal chain as a skeleton, and having mesogen groups including cyclic units etc. in side chains may be mentioned. As the above-mentioned cyclic units used as mesogen groups, biphenyl based, phenyl benzoate based, phenylcyclohexane based, azoxybenzene based, azomethine based, azobenzene based, phenyl pyrimidine based, diphenyl acetylene based, diphenyl benzoate based, bicyclo hexane based, cyclohexylbenzene based, terphenyl based units, etc. may be mentioned. Terminal groups of these cyclic units may have substituents, such as cyano group, alkyl group, alkenyl group, alkoxy group, halogen group, haloalkyl group, haloalkoxy group, and haloalkenyl group. Groups having halogen groups may be used for phenyl groups of mesogen groups.

Besides, any mesogen groups of the liquid crystal polymer may be bonded via a spacer part giving flexibility. As spacer parts, polymethylene chain, polyoxymethylene chain, etc. may be mentioned. A number of repetitions of structural units forming the spacer parts is suitably determined by chemical structure of mesogen parts, and the number of repeating units of polymethylene chain is 0 to 20, preferably 2 to 12, and the number of repeating units of polyoxymethylene chain is 0 to 10, and preferably 1 to 3.

The above-mentioned liquid crystalline thermoplastic resins preferably have glass transition temperatures of 50° C. or more, and more preferably 80° C. or more. Furthermore they have approximately 2,000 to 100,000 of weight average molecular weight.

As liquid crystalline monomers, monomers having polymerizable functional groups, such as acryloyl groups and methacryloyl groups, at terminal groups, and further having mesogen groups and spacer parts including the above-mentioned cyclic units etc. may be mentioned. Crossed-linked structures may be introduced using polymerizable functional groups having two or more acryloyl groups, methacryloyl groups, etc., and durability may also be improved.

Materials forming minute domains 13 are not entirely limited to the above-mentioned liquid crystalline materials, and non-liquid crystalline resins may be used if they are different materials from the matrix materials. As the above-mentioned resins, polyvinyl alcohols and derivatives thereof, polyolefins, polyallylates, polymethacrylates, polyacrylamides, polyethylene terephthalates, acrylic styrene copolymes, etc. may be mentioned. Moreover, particles without birefringence may be used as materials for forming the minute domains 13. As fine-particles concerned, resins, such as polyacrylates and acrylic styrene copolymers, may be mentioned. A size of the fine-particles is not especially limited, and particle diameters of 0.05 to 500 μm may be used, and preferably 0.5 to 100 μm. Although it is preferable that materials for forming minute domains 13 is of the above-mentioned liquid crystalline materials, non-liquid crystalline materials may be mixed and used to the above-mentioned liquid crystalline materials. Furthermore, as materials for forming minute domains 13, non-liquid crystalline materials may also be independently used.

As the absorbing dichroic material 12, an iodine based light-absorbing material, absorbing dichroic dyes, absorbing dichroic pigments and the like are exemplified. In the case where the optically-transparent resin 11 used as the matrix material is a water-soluble resin such as polyvinyl alcohol, iodine based light-absorbing materials are particularly preferred in terms of high degree of polarization and high transmittance.

Iodine based light absorbing material means chemical species comprising iodine and absorbs visible light, and it is thought that, in general, they are formed by interaction between optically-transparent water-soluble resins (particularly polyvinyl alcohol based resins) and poly iodine ions (I₃_{^{−}}, I₅_{^{−}}, etc.). An iodine based light absorbing material is also called an iodine complex. It is thought that poly iodine ions are generated from iodine and iodide ions.

Iodine based light absorbing materials having an absorption band at least in a wavelength range of 400 to 700 nm is preferably used.

Preferably used are absorbing dichroic dyes that have heat resistance and do not lose their dichroism by decomposition or degradation even when the birefringent liquid-crystalline material is aligned by heating. As described above, the absorbing dichroic dye preferably has at least one absorption band with a dichroic ratio of at least 3 in the visible wavelength range. In the evaluation of the dichroic ratio, for example, an appropriate liquid crystal material containing a dissolved dye is used to form a homogeneously aligned liquid crystal cell, and the cell is measured for a polarized absorption spectrum, in which the absorption dichroic ratio at the absorption maximum wavelength is used as an index for evaluating the dichroic ratio. In this evaluation method, E-7 manufactured by Merck & Co. may be used as a standard liquid crystal. In this case, the dye to be used should generally have a dichroic ratio of at least about 3, preferably of at least about 6, more preferably of at least about 9, at the absorption wavelength.

Examples of the dye having such a high dichroic ratio include azo dyes, perylene dyes and anthraquinone dyes, which are preferably used for dye polarizers. Any of these dyes may be used in the form of a mixed dye. For example, these dyes are described in detail in JP-A No. 54-76171.

In the case where a color polarizer is produced, a dye having an absorption wavelength appropriate to the properties of the polarizer may be used. In the case where a neutral gray polarizer is produced, two or more types of dyes may be appropriately mixed such that absorption can occur over the whole visible light range.

In a complex type scattering-dichroic absorbing polarizer of this invention, while producing a film in which a matrix is formed with an optically-transparent water-soluble resin 11 including an absorbing dichroic material 12, minute domains 13 (for example, an oriented birefringent material formed with liquid crystalline materials) are dispersed in the matrix concerned. Moreover, the above-mentioned refractive index difference (Δn¹) in a Δn¹ direction and a refractive index difference (Δn²) in a Δn² direction are controlled to be in the above-mentioned range in the film.

Manufacturing process of a complex type absorbing polarizer of this invention is not especially limited, and for example, the polarizer of this invention may be obtained using following production processes:

(1) a process for manufacturing a mixed solution in which a material for forming minute domains is dispersed in an optically-transparent water-soluble resin forming a matrix (description is, hereinafter, to be provided, with reference to an example of representation, for a case where a liquid crystalline material is used as a material forming the minute domains. A case by a liquid crystalline material will apply to a case by other materials.);

(2) a process in which a film is formed with the mixed solution of the above-mentioned (1);

(3) a process in which the film obtained in the above-mentioned (2) is oriented (stretched); and

(4) a process in which an absorbing dichroic material is dispersed (dyed) in the optically-transparent water-soluble resin forming the above-mentioned matrix.

In addition, an order of the processes (1) to (4) may suitably be determined.

In the above-mentioned process (1), a mixed solution is firstly prepared in which a liquid crystalline material forming minute domains is dispersed in an optically-transparent water-soluble resin forming a matrix. A method for preparing the mixed solution concerned is not especially limited, and a method may be mentioned of utilizing a phase separation phenomenon between the above-mentioned matrix component (an optically-transparent water-soluble resin) and a liquid crystalline material. For example, a method may be mentioned in which a material having poor compatibility between the matrix component as a liquid crystalline material is selected, a solution of the material forming the liquid crystalline material is dispersed using dispersing agents, such as a surface active agent, in a water solution of the matrix component. In preparation of the above-mentioned mixed solution, some of combinations of the optically-transparent material forming the matrix, and the liquid crystal material forming minute domains do not require a dispersing agent. An amount used of the liquid crystalline material dispersed in the matrix is not especially limited, and a liquid crystalline material is 0.01 to 100 parts by weight to an optically-transparent water-soluble resin 100 parts by weight, and preferably it is 0.1 to 10 parts by weight. The liquid crystalline material is used in a state dissolved or not dissolved in a solvent. Examples of solvents, for example, include: water, toluene, xylene, hexane cyclohexane, dichloromethane, trichloromethane, dichloroethane, trichloroethane, tetrachloroethane, trichloroethylene, methyl ethyl ketone, methylisobutylketone, cyclohexanone, cyclopentanone, tetrahydrofuran, ethyl acetate, etc. Solvents for the matrix components and solvents for the liquid crystalline materials may be of same, or may be of different solvents.

In the above-mentioned process (2), in order to reduce foaming in a drying process after a film formation, it is desirable that solvents for dissolving the liquid crystalline material forming minute domains is not used in preparation of the mixed solution in the process (1). When solvents are not used, for example, a method may be mentioned in which a liquid crystalline material is directly added to an aqueous solution of an optically-transparency material forming a matrix, and then is heated above a liquid crystal temperature range in order to disperse the liquid crystalline material uniformly in a smaller state.

In addition, a solution of a matrix component, a solution of a liquid crystalline material, or a mixed solution may include various kinds of additives, such as dispersing agents, surface active agents, ultraviolet absorption agents, flame retardants, antioxidants, plasticizers, mold lubricants, other lubricants, and colorants in a range not disturbing an object of this invention.

In the process (2) for obtaining a film of the above-mentioned mixed solution, the above-mentioned mixed solution is heated and dried to remove solvents, and thus a film with minute domains dispersed in the matrix is produced. As methods for formation of the film, various kinds of methods, such as casting methods, extrusion methods, injection molding methods, roll molding methods, and flow casting molding methods, may be adopted. In film molding, a size of minute domains in the film is controlled to be in a range of 0.05 to 500 μm in a Δn² direction. Sizes and dispersibility of the minute domains may be controlled, by adjusting a viscosity of the mixed solution, selection and combination of the solvent of the mixed solution, dispersant, and thermal processes (cooling rate) of the mixed solvent and a rate of drying. For example, a mixed solution of an optically-transparent water-soluble resin that has a high viscosity and generates high shearing force and that forms a matrix, and a liquid crystalline material forming minute domains is dispersed by agitators, such as a homogeneous mixer, being heated at a temperature in no less than a range of a liquid crystal temperature, and thereby minute domains may be dispersed in a smaller state.

The process (3) giving orientation to the above-mentioned film may be performed by stretching the film. In stretching, uniaxial stretching, biaxial stretching, diagonal stretching are exemplified, but uniaxial stretching is usually performed. Any of dries type stretching in air and wet type stretching in an aqueous system bath may be adopted as the stretching method. When adopting a wet type stretching, an aqueous system bath may include suitable additives (boron compounds, such as boric acid; iodide of alkali metal, etc.) A stretching ratio is not especially limited, and in usual a ratio of approximately 2 to 10 times is preferably adopted.

This stretching may orient the absorbing dichroic material in a direction of stretching axis. Moreover, the liquid crystalline material forming a birefringent material is oriented in the stretching direction in minute domains by the above-mentioned stretching, and as a result birefringence is demonstrated.

It is desirable the minute domains may be deformed according to stretching. When minute domains are of non-liquid crystalline materials, approximate temperatures of glass transition temperatures of the resins are desirably selected as stretching temperatures, and when the minute domains are of liquid crystalline materials, temperatures making the liquid crystalline materials exist in a liquid crystal state such as nematic phase or smectic phase or an isotropic phase state, are desirably selected as stretching temperatures. When inadequate orientation is given by stretching process, processes, such as heating orientation treatment, may separately be added.

In addition to the above-mentioned stretching, function of external fields, such as electric field and magnetic field, may be used for orientation of the liquid crystalline material. Moreover, liquid crystalline materials mixed with light reactive substances, such as azobenzene, and liquid crystalline materials having light reactive groups, such as a cinnamoyl group, introduced thereto are used, and thereby these materials may be oriented by orientation processing with light irradiation etc. Furthermore, a stretching processing and the above-mentioned orientation processing may also be used in combination. When the liquid crystalline material is of liquid crystalline thermoplastic resins, it is oriented at the time of stretching, cooled at room temperatures, and thereby orientation is fixed and stabilized. Since target optical property will be demonstrated if orientation is carried out, the liquid crystalline monomer may not necessarily be in a cured state. However, in liquid crystalline monomers having low isotropic transition temperatures, a few temperature rise provides an isotropic state. In such a case, since anisotropic scattering may not be demonstrated but conversely polarized light performance deteriorates, the liquid crystalline monomers are preferably cured. Besides, many of liquid crystalline monomers will be crystallized when left at room temperatures, and then they will demonstrate anisotropic scattering and polarized light performance conversely deteriorate, the liquid crystalline monomers are preferably cured. In the view point of these phenomena, in order to make orientation state stably exist under any kind of conditions, liquid crystalline monomers are preferably cured. In curing of a liquid crystalline monomer, for example, after the liquid crystalline monomer is mixed with photopolymerization initiators, dispersed in a solution of a matrix component and oriented, in either of timing (before dyed or after dyed by absorbing dichroic materials), the liquid crystalline monomer is cured by exposure with ultraviolet radiation etc. to stabilize orientation. Desirably, the liquid crystalline monomer is cured before dyed with absorbing dichroic materials.

As a process (4) in which the absorbing dichroic material is dispersed in the optically-transparent water-soluble resin used for forming the above-mentioned matrix, in general, a method in which the above-mentioned film is immersed into a bath of aqueous system including the absorbing dichroic material. Timing of immersing may be before or after the above-mentioned stretching process (3). In a case iodine is used as the absorbing dichroic material, the bath of aqueous system preferably include auxiliary agents of iodide of alkali metals, such as potassium iodide. As mentioned above, an absorbing dichroic material is formed by interaction between iodine dispersed in the matrix and the matrix resin. The iodine based light-absorbing material is, in general, remarkably formed by being passed through a stretching process. A concentration of the aqueous system bath including iodine, and a percentage of the auxiliary agents, such as iodide of alkali metals may not especially be limited, but general iodine dyeing techniques may be adopted, and the above-mentioned concentration etc. may arbitrarily be changed.

In a case iodine is used as the absorbing dichroic material, a percentage of the iodine in the polarizer obtained is not especially limited, but a percentage of the optically-transparent water-soluble resin and the iodine are preferably controlled so that the iodine is 0.05 to 50 parts by weight grade to the optically-transparent water-soluble resin 100 parts by weight, and more preferably 0.1 to 10 parts by weight.

In a case the absorbing dichroic dye is used as the absorbing dichroic material, a percentage of the absorbing dichroic dye in the polarizer obtained is not especially limited, but a percentage of the optically-transparent thermoplastic resin and the absorbing dichroic dye is preferably so that the absorbing dichroic dye is controlled to be 0.01 to 100 parts by weight grade to the optically-transparent thermoplastic resin 100 parts by weight, and more preferably 0.05 to 50 parts by weight.

In production of the complex type absorbing polarizer, processes for various purposes (5) may be given other than the above-mentioned processes (1) to (4). As a process (5), for example, a process in which a film is immersed in water bath and swollen may be mentioned for the purpose of mainly improving iodine dyeing efficiency of the film. Besides, a process in which a film is immersed in a water bath including arbitrary additives dissolved therein may be mentioned. A process in which a film is immersed in an aqueous solution including additives, such as boric acid and borax, for the purpose of cross-linking a water-soluble resin (matrix) may be mentioned. Moreover, for the purpose of mainly adjusting an amount balance of the dispersed absorbing dichroic materials, and adjusting a hue, a process in which a film is immersed to an aqueous solution including additives, such as an iodide of an alkaline metals may be mentioned.

As for the process (3) of orienting (stretching) of the above-mentioned film, the process (4) of dispersing and dyeing the absorbing dichroic material to a matrix resin and the above-mentioned process (5), so long as each of the processes (3) and (4) is provided at least 1 time, respectively, a number, order and conditions (a bath temperature, immersion period of time, etc.) of the processes, may arbitrarily be selected, each process may separately be performed and furthermore a plurality of processes may simultaneously be performed. For example, a cross-linking process of the process (5) and the stretching process (3) may be carried out simultaneously.

In addition, although the absorbing dichroic material used for dyeing, boric acid used for cross-linking are permeated into a film by immersing the film in an aqueous solution as mentioned above, instead of this method, a method may be adopted that arbitrary types and amounts may be added before film formation of the process (2) and before or after preparation of a mixed solution in the process (1). And both methods may be used in combination. However, when high temperatures (for example, no less than 80° C.) is required in the process (3) at the time of stretching etc., in the view point of heat resistance of the absorbing dichroic material, the process (4) for dispersing and dyeing the absorbing dichroic material may be desirably performed after the process (3).

A film given the above treatments is desirably dried using suitable conditions. Drying is performed according to conventional methods.

A thickness of the obtained polarizer (film) is not especially limited, in general, but it is 1 μm to 3 mm, preferably 5 μm to 1 mm, and more preferably 10 to 500 μm.

A polarizer obtained in this way does not especially have a relationship in size between a refractive index of the birefringent material forming minute domains and a refractive index of the matrix resin in a stretching direction, whose stretching direction is in a Δn¹ direction and two directions perpendicular to a stretching axis are Δn² directions. Moreover, the stretching direction of an absorbing dichroic material is in a direction demonstrating maximal absorption, and thus a polarizer having a maximally demonstrated effect of absorption and scattering may be realized.

Any of transparent protective films provided on the complex type absorbing polarizer can be used without any particular limitation thereon, as far as an in-plane retardation Re₁ thereof is 10 nm or less and a thickness direction retardation Rth is in the range of from 30 to 100 nm. Examples of materials forming such a transparent protective film include: for example, polyester type polymers, such as polyethylene terephthalate and polyethylenenaphthalate; cellulose type polymers, such as diacetyl cellulose and triacetyl cellulose; acrylics type polymer, such as poly methylmethacrylate; styrene type polymers, such as polystyrene and acrylonitrile-styrene copolymer (AS resin); polycarbonate type polymer may be mentioned. Besides, as examples of the polymer forming a protective film, polyolefin type polymers, such as polyethylene, polypropylene, polyolefin that has cyclo-type or norbornene structure, ethylene-propylene copolymer; vinyl chloride type polymer; amide type polymers, such as nylon and aromatic polyamide; imide type polymers; sulfone type polymers; polyether sulfone type polymers; polyether-ether ketone type polymers; poly phenylene sulfide type polymers; vinyl alcohol type polymer; vinylidene chloride type polymers; vinyl butyral type polymers; arylate type polymers; polyoxymethylene type polymers; epoxy type polymers; or blend polymers of the above-mentioned polymers may be mentioned. In addition, a film comprising resins of heat curing type or ultraviolet curing type, such as acrylics type, urethane type, acrylics urethane type and epoxy type and silicone type may be mentioned. As a material of the transparent protective film, preferable is triacetyl cellulose generally used as a transparent protective film for a polarizer. Transparent protective films can be suitably stretched so as to obtain an in-plane retardation Re₁ in the range and a thickness direction retardation Rth in the range.

As the opposite side of the polarizing-adhering surface above-mentioned transparent protective film, a film with a hard coat layer and various processing aiming for antireflection, sticking prevention and diffusion or anti glare may be used.

A hard coat processing is applied for the purpose of protecting the surface of the polarizing plate from damage, and this hard coat film may be formed by a method in which, for example, a curable coated film with excellent hardness, slide property etc. is added on the surface of the protective film using suitable ultraviolet curable type resins, such as acrylic type and silicone type resins. Antireflection processing is applied for the purpose of antireflection of outdoor daylight on the surface of a polarizing plate and it may be prepared by forming an antireflection film according to the conventional method etc. Besides, a sticking prevention processing is applied for the purpose of adherence prevention with adjoining layer.

In addition, an anti glare processing is applied in order to prevent a disadvantage that outdoor daylight reflects on the surface of a polarizing plate to disturb visual recognition of transmitting light through the polarizing plate, and the processing may be applied, for example, by giving a fine concavo-convex structure to a surface of the protective film using, for example, a suitable method, such as rough surfacing treatment method by sandblasting or embossing and a method of combining transparent fine particle. As a fine particle combined in order to form a fine concavo-convex structure on the above-mentioned surface, transparent fine particles whose average particle size is 0.5 to 50 μm, for example, such as inorganic type fine particles that may have conductivity comprising silica, alumina, titania, zirconia, tin oxides, indium oxides, cadmium oxides, antimony oxides, etc., and organic type fine particles comprising cross-linked of non-cross-linked polymers may be used. When forming fine concavo-convex structure on the surface, the amount of fine particle used is usually about 2 to 50 weight parts to the transparent resin 100 weight parts that forms the fine concavo-convex structure on the surface, and preferably 5 to 25 weight parts. An anti glare layer may serve as a diffusion layer (viewing angle expanding function etc.) for diffusing transmitting light through the polarizing plate and expanding a viewing angle etc.

In addition, the above-mentioned antireflection layer, sticking prevention layer, diffusion layer, anti glare layer, etc. may be built in the transparent protective film itself, and also they may be prepared as an optical layer different from the transparent protective layer.

Isocyanate based adhesives, polyvinyl alcohol based adhesives, gelatin based adhesives, vinyl based latex based, aqueous polyester based adhesives, and etc. may be used for adhesion processing for the above-mentioned polarizers and transparent protective films.

Any of retardation films can be used without any particular limitation thereon, as far as an Nz value is in the range of from 0.1 to 0.8 and an in-plane retardation value Re₂ is in the range of from 60 to 300 nm. Examples of retardation films include: a birefringent film made from a polymer film; an alignment film made from a liquid crystal polymer and others.

Exemplified polymers are: polycarbonate; polyolefins, such as and polypropylene; polyesters, such as polyethylene terephthalate and polyethylenenaphthalate; cycloaliphatic polyolefins, such as poly norbornene etc.; polyvinyl alcohols; polyvinyl butyrals; polymethyl vinyl ethers; poly hydroxyethyl acrylates; hydroxyethyl celluloses; hydroxypropyl celluloses; methylcelluloses; polyarylates; polysulfones; polyether sulfones; polyphenylene sulfides; polyphenylene oxides; poly aryl sulfones; polyvinyl alcohols; polyamides; polyimides; polyvinyl chlorides; cellulose based polymers; or various kinds of binary copolymers; ternary copolymers; and graft copolymers of the above-mentioned polymers; or their blended materials. A retardation film can be obtained by adjusting a refractive index in a thickness direction using a method in which a polymer film is biaxially stretched in a planar direction, or a method in which a high polymer film is uniaxially or biaxially stretched in a planar direction, and also stretched in a thickness direction etc. And a retardation film can be obtained using, for example, a method in which a heat shrinking film is adhered to a polymer film, and then the combined film is stretched and/or shrunk under a condition of being influenced by a contractile force to obtain tilted orientation.

As liquid crystalline polymers, for example, various kinds of principal chain type or side chain type polymers may be mentioned in which conjugated linear atomic groups (mesogen) demonstrating liquid crystal alignment property are introduced into a principal chain and a side chain of the polymer. As illustrative examples of principal chain type liquid crystalline polymers, for example, nematic orientated polyester based liquid crystalline polymers having a structure where mesogenic group is bonded by a spacer section giving flexibility, discotic polymers, and cholesteric polymers, etc. may be mentioned. As illustrative examples of side chain type liquid crystalline polymers, there may be mentioned a polymer having polysiloxanes, polyacrylates, polymethacrylates, or poly malonates as a principal chain skeleton, and having a mesogen section including a para-substituted cyclic compound unit giving nematic orientation through a spacer section comprising conjugated atomic group as side chain. As preferable examples of oriented films obtained from these liquid crystalline polymers, there may be mentioned a film whose surface of a thin film made of polyimide or polyvinyl alcohol etc. formed on a glass plate is treated by rubbing, and a film obtained in a method that a solution of a liquid crystalline polymer is applied on an oriented surface of a film having silicon oxide layer vapor-deposited by an oblique vapor deposition method and subsequently the film is heat-treated to give orientation of the liquid crystal polymer, and among them, a film given tilted orientation is especially preferable.

A laminating method for the above-mentioned retardation films and polarizing plates is not especially limited, and lamination may be carried out using pressure sensitive adhesive layers etc. As pressure sensitive adhesive that forms adhesive layer is not especially limited, and, for example, acrylic type polymers; silicone type polymers; polyesters, polyurethanes, polyamides, polyethers; fluorine type and rubber type polymers may be suitably selected as a base polymer. Especially, a pressure sensitive adhesive such as acrylics type pressure sensitive adhesives may be preferably used which is excellent in optical transparency, showing adhesion characteristics with moderate wettability, cohesiveness and adhesive property and has outstanding weather resistance, heat resistance, etc.

In addition, ultraviolet absorbing property may be given to the above-mentioned each layer, such as an optical film etc. and an adhesive layer, using a method of adding UV absorbents, such as salicylic acid ester type compounds, benzophenol type compounds, benzotriazol type compounds, cyano acrylate type compounds, and nickel complex salt type compounds.

An optical film of the present invention is suitably used for a liquid crystal display in IPS mode. A liquid crystal display in IPS mode has a liquid crystal cell comprising: a pair of substrates sandwiching a liquid crystal layer; a group of electrodes formed on one of the above-mentioned pair of substrates; a liquid crystal composition material layer having dielectric anisotropy sandwiched between the above-mentioned substrates; an orientation controlling layer that is formed on each of surfaces, facing each other, of the above-mentioned pair of substrates in order to orient molecules of the above-mentioned liquid crystal composition material in a predetermined direction, and driving means for applying driver voltage to the above-mentioned group of electrodes. The above-mentioned group of electrodes has alignment structure arranged so that parallel electric field may mainly be applied to an interface to the above-mentioned orientation controlling layer and the above-mentioned liquid crystal composition material layer. The liquid crystal cell has preferably a retardation value in the range of 230 to 360 nm at 550 nm when no voltage is applied, which has been described above.

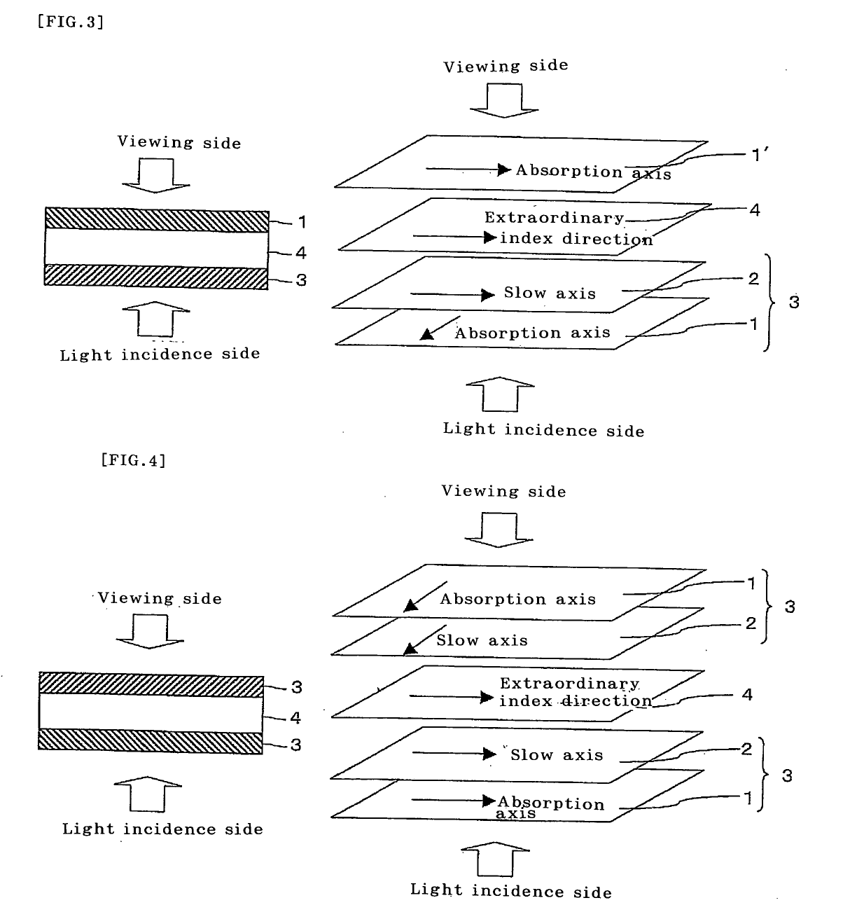

An optical film 3 of the invention is disposed on at least one of the viewing side and the light incidence side of a liquid crystal cell. FIG. 2 shows a case where the optical film 3 is disposed on the viewing side, while FIG. 3 shows a case where the optical film 3 is disposed on the light incidence side. FIG. 4 shows a case where the optical films 3 are disposed on the viewing side and the light incidence side, respectively. The optical film or optical films 3 are as shown in FIGS. 2 to 4 preferably disposed so as to place a retardation film or retardation films face the liquid crystal cell 4.

In FIGS. 2 and 3, the optical film 3 is a laminate obtained by laminating the complex type absorbing polarizing plate 1 and the retardation film 2 so that the absorption axis of the polarization plate 1 and the slow axis of the retardation film 2 are perpendicular to each other. The polarizing plate 1′ is disposed on the other side of the liquid cell 4 from the optical film 3 disposed thereon. The absorption axes of the polarizing plates 1′ and the optical films 3 (the polarizing plate 1) on substrates of the liquid crystal cell 4 at both sides thereof are disposed so as to be perpendicular to each other. The polarizing plate 1′ may be a complex type absorbing polarizing plate 1, which is obtained by laminating a transparent protective film 2b on both surfaces of a complex type absorbing polarizer 1a, is similar to that used in the optical film 3, or a conventional polarizing plate. The complex type absorbing polarizing plate 1 is preferably used as the polarizing plate 1′.

In the case where the optical film 3 is, as shown in FIG. 2, disposed on the viewing side of the liquid cell 4 in IPS mode, it is preferable to dispose a polarizing plate 1′ on the substrate of the liquid crystal cell 4 on the other side (light incidence side) thereof from the viewing side so that an extraordinary index direction of a liquid crystal material in the liquid crystal cell 4 when no voltage is applied and the absorption axis of the polarizing plate 1 therein are parallel to each other.

In the case where the optical film 3 is, as shown in FIG. 3, disposed on the light incidence side of the liquid cell 4 in IPS mode, it is preferable to dispose a polarizing plate 1′ on the substrate of the liquid crystal cell 4 on the viewing thereof so that an extraordinary index direction of a liquid crystal material in the liquid crystal cell 4 when no voltage is applied and the absorption axis of the polarizing plate 1 in the optical film 3 are perpendicular to each other.

In the case of FIG. 4 where the optical films 3 are laminates each obtained by laminating a polarizing plate 1 and a retardation film 2 so that the absorption axis of the polarizing plate 1 and the slow axis of the retardation film 2 are parallel to each other. The absorption axes of the optical films 3 (the polarizing plates 1) disposed on respective both sides of the liquid crystal cell 4 at the substrates thereof are arranged to be perpendicular to each other. In the case where the optical films 3 are, as shown in FIG. 4, disposed on respective both sides of the liquid crystal cell 4 in IPS mode, it is preferable to dispose the optical films 3 on respective both sides of the liquid crystal 4 so that an extraordinary index direction of a liquid crystal material in the liquid crystal cell 4 when no voltage is applied and the absorption axis of the polarizing plate 1 in the optical film 3 on the light incidence side are parallel to each other.

The above-mentioned optical film and polarizing plate may be used in a state where other optical films are laminated thereto on the occasion of practical use. The optical films used here are not especially limited, and, for example, one layer or two or more layers of optical films that may be used for formation of liquid crystal displays, such as reflectors, semitransparent plates, and retardation plates (including half wavelength plates and quarter wavelength plates etc.) may be used. Especially, a polarizing plate in which a brightness enhancement film is further laminated to a polarizing plate is preferable.

The polarizing plate on which the retardation plate is laminated may be used as elliptically polarizing plate or circularly polarizing plate. These polarizing plates change linearly polarized light into elliptically polarized light or circularly polarized light, elliptically polarized light or circularly polarized light into linearly polarized light or change the polarization direction of linearly polarization by a function of the retardation plate. As a retardation plate that changes circularly polarized light into linearly polarized light or linearly polarized light into circularly polarized light, what is called a quarter wavelength plate (also called λ/4 plate) is used. Usually, half-wavelength plate (also called λ/2 plate) is used, when changing the polarization direction of linearly polarized light.

Elliptically polarizing plate is effectively used to give a monochrome display without above-mentioned coloring by compensating (preventing) coloring (blue or yellow color) produced by birefringence of a liquid crystal layer of a liquid crystal display. Furthermore, a polarizing plate in which three-dimensional refractive index is controlled may also preferably compensate (prevent) coloring produced when a screen of a liquid crystal display is viewed from an oblique direction. Circularly polarizing plate is effectively used, for example, when adjusting a color tone of a picture of a reflection type liquid crystal display that provides a colored picture, and it also has function of antireflection.

The polarizing plate with which a polarizing plate and a brightness enhancement film are adhered together is usually used being prepared in a backside of a liquid crystal cell. A brightness enhancement film shows a characteristic that reflects linearly polarized light with a predetermined polarization axis, or circularly polarized light with a predetermined direction, and that transmits other light, when natural light by back lights of a liquid crystal display or by reflection from a back-side etc., comes in. The polarizing plate, which is obtained by laminating a brightness enhancement film to a polarizing plate, thus does not transmit light without the predetermined polarization state and reflects it, while obtaining transmitted light with the predetermined polarization state by accepting a light from light sources, such as a backlight. This polarizing plate makes the light reflected by the brightness enhancement film further reversed through the reflective layer prepared in the backside and forces the light re-enter into the brightness enhancement film, and increases the quantity of the transmitted light through the brightness enhancement film by transmitting a part or all of the light as light with the predetermined polarization state. The polarizing plate simultaneously supplies polarized light that is difficult to be absorbed in a polarizer, and increases the quantity of the light usable for a liquid crystal picture display etc., and as a result luminosity may be improved.

A diffusion plate may also be prepared between brightness enhancement film and the above described reflective layer, etc. A polarized light reflected by the brightness enhancement film goes to the above described reflective layer etc., and the diffusion plate installed diffuses passing light uniformly and changes the light state into depolarization at the same time. That is, the diffusion plate returns polarized light to natural light state. Steps are repeated where light, in the unpolarized state, i.e., natural light state, reflects through reflective layer and the like, and again goes into brightness enhancement film through diffusion plate toward reflective layer and the like. Diffusion plate that returns polarized light to the natural light state is installed between brightness enhancement film and the above described reflective layer, and the like, in this way, and thus a uniform and bright screen may be provided while maintaining brightness of display screen, and simultaneously controlling non-uniformity of brightness of the display screen. By preparing such diffusion plate, it is considered that number of repetition times of reflection of a first incident light increases with sufficient degree to provide uniform and bright display screen conjointly with diffusion function of the diffusion plate.

The suitable films are used as the above-mentioned brightness enhancement film. Namely, multilayer thin film of a dielectric substance; a laminated film that has the characteristics of transmitting a linearly polarized light with a predetermined polarizing axis, and of reflecting other light, such as the multilayer laminated film of the thin film having a different refractive-index anisotropy (D-BEF and others manufactured by 3M Co., Ltd.); an oriented film of cholesteric liquid-crystal polymer; a film that has the characteristics of reflecting a circularly polarized light with either left-handed or right-handed rotation and transmitting other light, such as a film on which the oriented cholesteric liquid crystal layer is supported (PCF350 manufactured by Nitto Denko CORPORATION, Transmax manufactured by Merck Co., Ltd., and others); etc. may be mentioned.

Therefore, in the brightness enhancement film of a type that transmits a linearly polarized light having the above-mentioned predetermined polarization axis, by arranging the polarization axis of the transmitted light and entering the light into a polarizing plate as it is, the absorption loss by the polarizing plate is controlled and the polarized light can be transmitted efficiently. On the other hand, in the brightness enhancement film of a type that transmits a circularly polarized light as a cholesteric liquid-crystal layer, the light may be entered into a polarizer as it is, but it is desirable to enter the light into a polarizer after changing the circularly polarized light to a linearly polarized light through a retardation plate, taking control an absorption loss into consideration. In addition, a circularly polarized light is convertible into a linearly polarized light using a quarter wavelength plate as the retardation plate.

A retardation plate that works as a quarter wavelength plate in a wide wavelength ranges, such as a visible-light region, is obtained by a method in which a retardation layer working as a quarter wavelength plate to a pale color light with a wavelength of 550 nm is laminated with a retardation layer having other retardation characteristics, such as a retardation layer working as a half-wavelength plate. Therefore, the retardation plate located between a polarizing plate and a brightness enhancement film may consist of one or more retardation layers.

In addition, also in a cholesteric liquid-crystal layer, a layer reflecting a circularly polarized light in a wide wavelength ranges, such as a visible-light region, may be obtained by adopting a configuration structure in which two or more layers with different reflective wavelength are laminated together. Thus a transmitted circularly polarized light in a wide wavelength range may be obtained using this type of cholesteric liquid-crystal layer.

Moreover, the polarizing plate may consist of multi-layered film of laminated layers of a polarizing plate and two of more of optical layers as the above-mentioned separated type polarizing plate. Therefore, a polarizing plate may be a reflection type elliptically polarizing plate or a semi-transmission type elliptically polarizing plate, etc. in which the above-mentioned reflection type polarizing plate or a transflective type polarizing plate is combined with above described retardation plate respectively.

Although optical films and polarizing plates having the above-mentioned optical films laminated thereto may be formed using methods in which they are laminated sequentially and separately in a manufacturing process of liquid crystal displays, films that are beforehand laminated and constituted as an optical film are superior in stability of quality, assembly work, etc., thus leading to advantages of improved manufacturing processes for liquid crystal displays. Suitable adhering means, such as adhesive layer, may be used for lamination for layers. In adhesion of the above-mentioned polarizing plate and other optical films, the optical axes may be arranged so that they have proper arrangement angles based on desired retardation characteristics etc.

Formation of a liquid crystal display may be carried out according to conventional methods. A liquid crystal display is generally formed using methods in which component parts, such as lighting systems, are suitably assembled, and driving circuits are subsequently incorporated, if necessary, and the present invention is not especially limited except that the above-mentioned optical film is used, and any methods according to conventional methods may be adopted. Also in liquid crystal cells, for example, liquid crystal cells of arbitrary type, such as VA type and π type, other than IPS mode type illustrated above may be used.

As liquid crystal displays, suitable liquid crystal displays, such as types using lighting systems or reflectors, may be formed. Furthermore, on the occasion of formation of liquid crystal displays, one layer of two or more layers of suitable parts, such as diffusion plates, anti-glare layer coatings, protective plates, prism arrays, lens array sheets, optical diffusion plates, and backlights, may be arranged in suitable position.

### EXAMPLES

While description is given of the invention in a concrete manner with examples, it should be noted that the invention is not limited by description in the examples.

Refractive indexes nx, ny and nz of a transparent protective film at 550 nm were firstly measured with an automatic birefringence analyzer KOBRA-21ADH, manufactured by Oji Scientific Instruments and thereafter, an in-plane retardation Re₁ and a thickness direction retardation Rth were calculated. Similar measurement was conducted on a retardation film and an Nz value and an in-plane retardation Re₂ were calculated. A retardation value of a liquid crystal cell at 550 nm when no voltage is applied was measured with the Senarmont method.

### Example 1

<Preparation of Complex Type Scattering-Dichroic Absorbing Polarizing Plate>

(Complex Type Scattering-Dichroic Absorbing Polarizer)

A polyvinyl alcohol aqueous solution with a solid matter content of 13 weight % in which a polyvinyl alcohol resin with a polymerization degree of 2400 and a saponification degree of 98.5%, a liquid crystalline monomer (a nematic liquid crystal temperature is in the range of from 40 to 700) having an acryloyl group at each of both terminals of a mesogen group and glycerin were mixed together so that a ratio of polyvinyl alcohol:a liquid crystalline monomer:glycerin=100:5:15 (in weight ratio) and the mixture was heated to a temperature equal to or higher than a liquid crystal temperature range and agitated with a homomixer to thereby obtain a mixed solution. Bubbles existing in the mixed solution were defoamed by leaving the solution at room temperature (23° C.) as it was, thereafter, the solution is coated by means of a casting method, subsequently thereto, and the wet coat was dried and to thereafter obtains a whitened mixed film with a thickness of 70 μm. The mixed film was heat-treated at 130° C. for 10 min.

The mixed film was immersed in a water bath at 30° C. and swollen, thereafter, the swollen film was stretched about three times while being immersed in an aqueous solution of iodine and potassium iodide in a ratio of 1 to 7 in weight (a dyeing bath, with a concentration of 0.32 weight %) at 30° C., thereafter the stretched film was further stretched to a total stretch magnification of being about six times while being immersed in a 3 weight % boric acid aqueous solution (crosslinking bath) at 50° C., followed by immersing further the stretched film in 4 weight % boric acid aqueous solution (crosslinking bath) at 50° C. Then, hue adjustment was conducted by immersing the film in 5 weight % potassium iodide aqueous solution bath at 30° C. Subsequent thereto, the film was dried at 50° C. for 4 minutes to obtain a polarizer of the present invention.

(Confirmation of Generation of Anisotropic Scattering and Measurement of Refractive Index)

The obtained polarizer was observed under a polarization microscope and it was able to be confirmed that numberless dispersed minute domains of a liquid crystalline monomer were formed in a polyvinyl alcohol matrix. The liquid crystalline monomer is oriented in a stretching direction and an average size of minute domains in the stretching direction (Δn¹ direction) was in the range of from 5 to 10 μm. And an average size of minute domains in a direction perpendicular to the stretching direction (Δn² direction) was in the range of from 0.5 to 3 μm.

Refractive indices of the matrix and the minute domain were separately measured. Measurement was conducted at 20° C. A refractive index of a stretched film constituted only of a polyvinyl alcohol film stretched in the same conditions as the wet stretching was measured with an Abbe's refractometer (measurement light wavelength with 589 nm) to obtain a refractive index in the stretching direction (Δn¹ direction)=1.54 and a refractive index in Δn² direction=1.52. Refractive indexes (nₑ: an extraordinary light refractive index and n₀: an ordinary light refractive index) of a liquid crystalline monomer were measured. An ordinary light refractive index n₀ was measured of the liquid crystalline monomer orientation-coated on a high refractive index glass which is vertical alignment-treated with an Abbe's refractometer (measurement light with 589 nm). On the other hand, the liquid crystalline monomer is injected into a liquid crystal cell which is homogenous alignment-treated and a retardation (Δn×d) was measured with an automatic birefringence measurement instrument (automatic birefringence meter KOBRA21ADH) manufactured by Ohoji Keisokuki K.K.) and a cell gap (d) was measured separately with an optical interference method to calculate Δn from retardation/cell gap and to obtain the sum of Δn and n₀ as nₑ. An extraordinary light refractive index nₑ (corresponding to a refractive index in the Δn¹ direction)=1.64 and n₀ (corresponding to a refractive index of Δn² direction)=1.52. Therefore, calculation was resulted in Δn¹=1.64−1.52=0.10 and Δn²=1.52−1.52=0.00. It was confirmed from the measurement described above that a desired anisotropic scattering was able to occur.

(Preparation of Polarizing Plate)

Triacetyl cellulose (TAC) films (transparent protective films with a thickness of 80 μm) were laminated onto respective both surfaces of the complex type absorbing polarizer, using an adhesive to obtain a complex type absorbing polarizing plate. A TAC film has an in-plane retardation Re₁ of 4 nm and a thickness direction retardation Rth of 50 nm.

### Example 1

(Optical Film)

A polycarbonate film was stretched at 150° C. in the presence of a heat-shrinkable film that was adhered to the polycarbonate film to obtain a retardation film having a thickness of 45 μm, an in-plane retardation Re₂ of 140 nm and Nz of 0.5. The retardation film and the complex type absorbing polarizing plate were laminated one on the other with an acrylic pressure sensitive adhesive so that an slow axis of the retardation film and an absorption axis of the complex type absorbing polarizing plate were perpendicular to each other to thereby prepare an optical film.

(Liquid Crystal Display)

A liquid crystal cell in IPS mode with a retardation value of 280 nm at 550 nm was employed and the optical film was, as shown in FIG. 3, laminated onto one side of the liquid crystal cell in IPS mode with an acrylic pressure sensitive adhesive so that the retardation film side of the optical film face a surface of the liquid crystal cell in IPS mode on the light incidence side. On the other hand, the complex type absorbing polarizing plate obtained above was laminated onto the surface of the other side of the liquid crystal cell with an acrylic pressure sensitive adhesive to thereby prepare a liquid crystal display. Lamination was conducted so that the absorption axis of the polarizing plate (the optical film) on the light incidence side and an extraordinary index direction of a liquid crystal in the liquid crystal cell were perpendicular to each other. A slow axis of the retardation film (the optical film) was parallel to the absorption axis of the polarizing plate on the viewing side. The absorption axis of the polarizing plate (the optical film) on the light incidence side was perpendicular to the absorption axis of the polarizing plate on the viewing side. A retardation value of a liquid crystal cell at 550 nm when no voltage is applied was measured with the Senarmont method.

### Example 2

(Optical Film)

A polycarbonate film was stretched at 150° C. in the presence of a heat-shrinkable film that was adhered to the polycarbonate film to obtain a retardation film having a thickness of 45 μm, an in-plane retardation Re₂ of 140 nm and Nz of 0.3. The retardation film and the complex type absorbing polarizing plate used in example 1 were laminated one on the other with an acrylic pressure sensitive adhesive so that an slow axis of the retardation film and an absorption axis of the complex type absorbing polarizing plate were perpendicular to each other to thereby prepare an optical film.

(Liquid Crystal Display)

A liquid crystal cell in IPS mode with a retardation value of 280 nm at 550 nm was employed and the optical film was, as shown in FIG. 2, laminated onto one side of the liquid crystal cell in IPS mode with an acrylic pressure sensitive adhesive so that the retardation film side of the optical film face a surface of the liquid crystal cell in IPS mode on the viewing side. On the other hand, the complex type absorbing polarizing plate obtained above was laminated onto the surface of the other side of the liquid crystal cell with an acrylic pressure sensitive adhesive to thereby prepare a liquid crystal display. Lamination was conducted so that the absorption axis of the polarizing plate (the optical film) on the light incidence side and an extraordinary index direction of a liquid crystal in the liquid crystal cell were parallel to each other. A slow axis of the retardation film (the optical film) was parallel to the absorption axis of the polarizing plate on the light incidence side. The absorption axis of the polarizing plate (the optical film) on the viewing side was perpendicular to the absorption axis of the polarizing plate on the light incidence side.

### Example 3

(Liquid Crystal Display)

A liquid crystal cell in IPS mode having a retardation value of 280 nm at 550 nm was adopted and the optical film used in Example 1 was, as shown in FIG. 3, laminated onto the liquid crystal cell in IPS mode with an acrylic pressure sensitive adhesive so that the retardation film side of the optical film face one surface of the liquid crystal cell in IPS mode on the light incidence side thereof. On the other hand, the polarizing plate (NPF-SEG1425DU manufactured by NITTO DENKO CORPORATION) was laminated onto the liquid crystal cell in IPS mode with an acrylic pressure sensitive adhesive an acrylic. In this case, lamination was conducted so that the absorption axis of the polarizing plate (the optical film) on the light incidence side was perpendicular to an extraordinary index direction that a liquid crystal in the liquid crystal cell has. The slow axis of the retardation film (the optical film) was parallel to the absorption axis of the polarizing plate on the viewing side. Lamination was conducted so that the absorption axis of the polarizing plate (the optical film) on the light incidence side was perpendicular to the absorption axis of the polarizing plate on the viewing side.

### Comparative Example 1

A polarizer was prepared in the same manner as described above, except that the liquid-crystalline monomer was not used in the preparation of the complex type scattering-dichroic absorbing polarizer. Using the resulting polarizer, a polarizing plate was prepared in the same manner as describe above. An optical film was also prepared using the process of Example 1, except that the resulting polarizing plate was alternatively used.

(Liquid Crystal Display)

A liquid crystal display was prepared in a similar way to that in Example 1 with the exception that the optical film prepared in the above procedure was adopted instead of the optical film in Example 1.

### Comparative Example 2

(Liquid Crystal Display)

The complex type absorbing polarizing plates prepared in Example 1 were laminated onto respective both sides of a liquid crystal cell in IPS mode used in Example 1 with a pressure sensitive adhesive to thereby prepare a liquid crystal display. In this case, the absorption axes of the polarizing plates disposed on both sides of the liquid crystal cell were disposed so as to be perpendicular to each other.

### Comparative Example 3

(Optical Film)

A polycarbonate film was stretched at 150° C. to thereby obtain a retardation film having a thickness of 50 μm, an in-plane retardation of Re₂ of 140 nm and Nz of 1. The retardation film and the polarizing plate prepared in Example 1 were laminated one on the other using a pressure sensitive adhesive so that the slow axis of the retardation film and the absorption axis of the polarizing plate were perpendicular to each other to thereby prepare an optical film.

(Liquid Crystal Display)

A liquid crystal display was prepared in a similar way to that in Example 1 with the exception that the optical film prepared in the above procedure was adopted instead of the optical film in Example 1.

(Evaluation)

Polarizing plates obtained in Example 1 and Comparative example 1 were measured for optical properties using a spectrophotometer with integrating sphere (manufactured by Hitachi Ltd. U-4100). Transmittance to each linearly polarized light was measured under conditions in which a completely polarized light obtained through Glan Thompson prism polarizer was set as 100%. Transmittance was calculated based on CIE 1931 standard calorimetric system, and is shown with Y value, for which relative spectral responsivity correction was carried out. Notation k₁ represents a transmittance of a linearly polarized light in a maximum transmittance direction, and k₂ represents a transmittance of a linearly polarized light perpendicular to the direction.

A polarization degree P was calculated with an equation P={(k₁−k₂)/(k₁+k₂)}×100. A transmittance T of a simple substance was calculated with an equation T=(k₁+k₂)/2.

Furthermore, polarizers obtained in Example 1 and Comparative example 1 were measured for a polarized light absorption spectrum using a spectrophotometer (manufactured by Hitachi Ltd. U-4100) with Glan Thompson prism. FIG. 5 shows polarized light absorption spectra of polarizers obtained in Example 1 and Comparative example 1. “MD polarized lights” in FIG. 5 (a) represent polarized light absorption spectra when a polarized light with a plane of vibration parallel to a stretching axis enters, and “TD polarized lights” in FIG. 5 (b) represent polarized light absorption spectra when a polarized light with a plane of vibration perpendicular to a stretching axis enters.

In TD polarized lights (=transmission axis of polarizer), in visible range whole band, while absorbance of the polarizers in Example 1 and Comparative example 1 showed almost equal value, in MD polarized lights (=absorption of polarizer+scattering axis), absorbance in the polarizer of Example 1 exceeded absorbance of the polarizer in Comparative example 1 in shorter wavelength side. That is, the above-mentioned result shows that light polarizing performance of the polarizer in Example 1 exceeded performance of the polarizer in Comparative example 1 in a short wavelength side. Since all conditions, such as stretching and dyeing, are equivalent in Example 1 and Comparative example 1, it is thought that orientation of iodine based light absorbing materials is also equivalent. Therefore, as mentioned above, a rise of absorbance in MD polarized light of the polarizer of Example 1 shows that light polarizing performance improved by an effect caused by an effect of anisotropic scattering having been added to absorption by iodine.

In haze values, a haze value to a linearly polarized light in a maximum transmittance direction, and a haze value to a linearly polarized light in an absorption direction (a perpendicular direction). Measurement of a haze value was performed according to JIS K7136 (how to obtain a haze of plastics-transparent material), using a haze meter (manufactured by Murakami Color Research Institute HM-150). A commercially available polarizing plate (NPF-SEG1224DU manufactured by NITTO DENKO CORP.: 43% of simple substance transmittances, 99.96% of polarization degree) was arranged on a plane of incident side of a measurement light of a sample, and stretching directions of the commercially available polarizing plate and the sample (polarizer) were made to perpendicularly intersect, and a haze value was measured. However, since quantity of light at the time of rectangular crossing is less than limitations of sensitivity of a detecting element when a light source of the commercially available haze meter is used, light by a halogen lamp which has high optical intensity provided separately was made to enter with a help of an optical fiber device, thereby quantity of light was set as inside of sensitivity of detection, and subsequently a shutter closing and opening motion was manually performed to obtain a haze value to be calculated.

TABLE 1

| | Transmittance of linearly | | | | | |
|---|---|---|---|---|---|---|
| | polarized light (%) | | Single | | haze value (%) | |
| | Maximum | | substance | | Maximum | |
| | transmission | Perpendicular | transmittance | Polarization | transmission | Perpendicular |
| | direction (k₁) | direction (k₂) | (%) | degree (%) | direction | direction |
| Example 1 | 87.00 | 0.035 | 43.53 | 99.92 | 1.8 | 82.0 |
| Comparative | 87.00 | 0.043 | 43.52 | 99.90 | 0.3 | 0.2 |
| Example 1 | | | | | | |

Table 1 shows that the polarizing plate in each of the example and the comparative example has good polarization properties such as a high single substance transmittance and a high degree of polarization. In the example, the polarizing plate uses a polarizer having a structure that includes a matrix formed of an optically-transparent water-soluble resin containing an iodine based light-absorbing material and minute domains dispersed in the matrix. Thus, it is apparent that the haze value with respect to the transmittance in the perpendicular direction is higher in the example than in the comparative example where the polarizing plate uses a conventional polarizer and that the unevenness caused by uneven transmittance is concealed by scattering so that it cannot be detected in the example.

The liquid crystal display obtained in each of Examples and Comparative Examples was evaluated as described below. The results are shown in Table 2.

70° Contrast Ratio: The liquid crystal display was placed on a backlight, and the contrast ratios in the vertical (normal) direction and in an oblique direction making an angle of 70° with the normal direction with an angle of 45° with respect to the optical axes of the crossed polarizing plates were measured using EZcontrast manufactured by ELDIM.

Unevenness: A level at which the unevenness was visually detectable was represented by the mark “x”, while a level at which the unevenness was not visually detectable was represented by the mark “∘.”

TABLE 2

| | Vertical Contrast | 70° Contrast | Unevenness |
|---|---|---|---|
| Example 1 | 350 | 55 | ∘ |
| Example 2 | 330 | 50 | ∘ |
| Example 3 | 390 | 50 | ∘ |
| Comparative | 400 | 50 | x |
| Example 1 | | | |
| Comparative | 290 | 12 | ∘ |
| Example 2 | | | |
| Comparative | 300 | 15 | ∘ |
| Example 3 | | | |

The results of Table 2 indicate that in contrast to the comparative examples, the unevenness caused by uneven transmittance is concealed by scattering in the examples, and relatively high contrast ratios and improved visibility are obtained in the examples.

As a complex type scattering-dichroic absorbing polarizer having a similar structure as a structure of a polarizer of this invention, a polarizer in which a mixed phase of a liquid crystalline birefringent material and an absorption dichroism material is dispersed in a resin matrix is disclosed in Japanese Patent Laid-Open No. 2002-207118, whose effect is similar as that of this invention. However, as compared with a case where an absorption dichroism material exists in dispersed phase as in Japanese Patent Laid-Open No. 2002-207118, since in a case where an absorption dichroism material exists in a matrix layer as in this invention a longer optical path length may be realized by which a scattered polarized light passes absorption layer, more scattered light may be absorbed. Therefore, this invention may demonstrate much higher effect of improvement in light polarizing performance. This invention may be realized with simple manufacturing process.

Although an optical system to which a dichroic dye is added to either of continuous phase or dispersed phase is disclosed in Japanese Patent Laid-Open No. 2000-506990, this invention has large special feature in a point of laminating a complex type absorbing polarizer and a retardation film, and special feature in applied for a liquid crystal cell driven in IPS mode. Especially this invention has large special feature in a point of using iodine as an absorption dichroism material of the complex type absorbing polarizer. The following advantages are realized when using not dichroic dye but iodine. (1) Absorption dichroism demonstrated with iodine is higher than by dichroic dye. Therefore, polarized light characteristics will also become higher if iodine is used for a polarizer obtained. (2) Iodine does not show absorption dichroism, before being added in a continuous phase (matrix phase), and after being dispersed in a matrix, an iodine based light absorbing material showing dichroism is formed by stretching. This point is different from a dichroic dye having dichroism before being added in a continuous phase. That is, iodine exists as iodine itself, when dispersed in a matrix. In this case, in general, iodine has a far effective diffusibility in a matrix compared with a dichroic dye. As a result, iodine based light absorbing material is dispersed to all corners of a film more excellently than dichroic dye. Therefore, an effect of increasing optical path length by scattering anisotropy can be utilized for maximum, which increases polarized light function.

A background of invention given in Japanese Patent Laid-Open No. 2000-506990 describes that optical property of a stretched film in which liquid droplets of a liquid crystal are arranged in a polymer matrix is indicated by Aphonin et al. However, Aphonin et al. has mentioned an optical film comprising a matrix phase and a dispersed phase (liquid crystal component), without using a dichroic dye, and since a liquid crystal component is not a liquid crystal polymer or a polymerized liquid crystal monomer, a liquid crystal component in the film concerned has a sensitive birefringence typically depending on temperatures. On the other hand, this invention provides a polarizer comprising a film having a structure where minute domains are dispersed in a matrix formed of an optically-transparent water-soluble resin including an iodine based light absorbing material, furthermore, in a liquid crystalline material of this invention, in the case of a liquid crystal polymer, after it is orientated in a liquid crystal temperature range, cooled to room temperatures and thus orientation is fixed, in the case of a liquid crystal monomer, similarly, after orientation, the orientation is fixed by ultraviolet curing etc., birefringence of minute domains formed by a liquid crystalline material does not change by the change of temperatures.

### INDUSTRIAL APPLICABILITY

An optical film of the invention is suited for use in a liquid crystal display driving in IPS mode, and especially for use in a transmissive liquid crystal display.

1. An optical film for a liquid crystal display laminated a polarizing plate and a retardation film so that an absorption axis of the polarizing plate and a slow axis of the retardation film are perpendicular or parallel to each other,
wherein the polarizing plate comprises a transparent protective film on both surfaces of a complex type scattering-dichroic absorbing polarizer including a monolayer film that has a structure having a minute domain dispersed in a matrix formed of an optically-transparent water-soluble resin including an absorbing dichroic material, and
the transparent protective film satisfies that an in-plane retardation Re₁=(nx₁−ny₁)×d₁ is 10 nm or less and
a thickness direction retardation Rth={(nx₁+ny₁)/2−nz₁}×d₁ is in the range of from 30 nm to 100 nm,
where a direction on the transparent protective film in which an in-plane refractive index gives maximum is defined as X axis, a direction perpendicular to X axis is defined as Y axis, a direction of the film thickness is defined as Z axis; and refractive indices at 550 nm in the respective axes directions are defined as nx₁, ny₁ and nz₁; and a thickness of the film is defined as d₁ (nm); and
the retardation film satisfies that an Nz value represented by Nz=(nx₂−nz₂)/(nx₂−ny₂) is in the range of from 0.1 to 0.8 and
an in-plane retardation Re₂=(nx₂−ny₂)×d₂ is in the range of from 60 to 300 nm,
where a direction on the retardation film in which an in-plane refractive index gives maximum is defined as X axis, a direction perpendicular to X axis is defined as Y axis, a direction perpendicular to X axis is defined as Y axis, a direction of the film thickness is defined as Z axis; and refractive indices at 550 nm in the respective axes directions are defined as nx₂, ny₂ and nz₂; and a thickness of the film is defined as d₂ (nm).

2. The optical film according to claim 1, wherein the minute domain of the complex type absorbing polarizer is formed of an oriented birefringent material.

3. The optical film according to claim 2, wherein the birefringent material shows liquid crystalline at least in orientation processing step.

4. The optical film according to claim 2, wherein the minute domain of the complex type absorbing polarizer has 0.02 or more of birefringence.

5. The optical film according to claim 2, wherein in a refractive index difference between the birefringent material forming the minute domain and the optically-transparent water-soluble resin of the complex type absorbing polarizer in each optical axis direction,
a refractive index difference (Δn¹) in direction of axis showing a maximum is 0.03 or more, and
a refractive index difference (Δn²) between the Δn¹ direction and a direction of axes of two directions perpendicular to the Δn¹ direction is 50% or less of the Δn¹.

6. The optical film according to claim 5, wherein an absorption axis of the absorbing dichroic material of the complex type absorbing polarizer is oriented in the Δn¹ direction.

7. The optical film according to claim 1, wherein the film used as the complex type absorbing polarizer is manufactured by stretching.

8. The optical film according to claim 5, wherein the minute domain of the complex type absorbing polarizer has a length of 0.05 to 500 μm in the Δn² direction.

9. The optical film according to claim 1, wherein the retardation film is a stretched film made of a transparent polymer film.

10. The optical film according to claim 1, wherein the complex type absorbing polarizer and the retardation film are laminated and fixed with a transparent acrylic pressure-sensitive adhesive.

11. The optical film according to claim 1, wherein a transmittance to a linearly polarized light in a transmission direction is 80% or more,
a haze value is 30% or less, and
a haze value to a linearly polarized light in an absorption direction is 30% or more, with regard to the complex type absorbing polarizer.

12. The optical film according to claim 1, applied to an IPS mode liquid crystal display comprising a liquid crystal cell driven in IPS mode.

13. The optical film according to claim 12, wherein the liquid crystal cell driven in IPS mode is a liquid crystal cell in IPS mode having a retardation value in the range of from 230 to 360 nm at 550 nm when no voltage is applied.

14. A transmissive liquid crystal display comprising: a liquid crystal cell containing a pair of substrates between which a liquid crystal layer is sandwiched, and driven in IPS mode; and a pair of polarizing plates disposed on both sides of the liquid crystal cells so that an absorption axis of the polarizing plates are perpendicular to each other,
wherein at least one of the polarizing plates is an optical film according to claim 12, and the optical film is disposed so that an retardation film side faces the liquid crystal cell.

15. The transmissive liquid crystal display according to claim 14,
wherein the optical film is disposed on a cell substrate on the viewing side, and
an extraordinary refractive index direction of a liquid crystal material in the liquid crystal cell when no voltage is applied and an absorption axis of the polarizing plate on the light incidence side are parallel to each other.

16. The transmissive liquid crystal display according to claim 14,
wherein the optical film is disposed on a cell substrate on the light incidence side, and
an extraordinary index direction of a liquid crystal material in the liquid crystal cell when no voltage is applied and an absorption axis of the polarizing plate in the optical film are perpendicular to each other.

17. The transmissive liquid crystal display according to claim 15, wherein the optical film comprises a polarizing plate and a retardation film so that an absorption axis of the polarizing plate and a slow axis of the retardation film are perpendicular to each other.

18. The transmissive liquid crystal display according to claim 14,
wherein the optical film is disposed on a cell substrate on the viewing side and the light incidence side, and
an extraordinary index direction of a liquid crystal material in the liquid crystal cell when no voltage is applied and an absorption axis of the polarizing plate in the optical film on the light incidence side are parallel to each other.

19. The transmissive liquid crystal display according to claim 18, wherein the optical film comprises a polarizing plate and a retardation film so that an absorption axis of the polarizing plate and a slow axis of the retardation film are parallel to each other.

20. The transmissive liquid crystal display according to claim 18, wherein an in-plane retardation Re₂ of the retardation film in the optical film disposed on the cell substrate on the light incidence side is smaller than an in-plane retardation Re₂ of the retardation film in the optical film disposed on the cell substrate on the viewing side.
